(19) United States
(12) Patent Application Publication
(10) Pub. No.: US 2017/0018997 A1
(43) Pub. Date: Jan. 19, 2017

(54) LIQUID COOLED EXTERNAL ROTOR ELECTRIC MACHINE

(71) Applicant: TM4 INC., Boucherville (CA)

(72) Inventors: Benjamin MARTINEAU, Varennes (CA); Martin HOULE, Laval (CA); Christian PRONOVOST, Longueuil (CA); Éric LATULIPE, Ste-Julie (CA)

(73) Assignee: TM4 INC., Boucherville, QC (CA)

(21) Appl. No.: 15/118,477

(22) PCT Filed: Feb. 4, 2015
(86) PCT No.: PCT/CA2015/050081

§ 371 Date: Aug. 11, 2016

Related U.S. Application Data
(60) Provisional application No. 61/938,770, filed on Feb. 12, 2014.

(51) Int. Cl. H02K 9/19; H02K 1/20; H02K 5/16; H02K 1/18

(52) U.S. Cl. CPC H02K 9/19; H02K 1/187; H02K 1/20; H02K 5/161

(57) ABSTRACT

An embodiment of a liquid cooled external rotor electric machine includes a stator, a generally cylindrical liquid cooling assembly secured to the stator therein, a rotor including a generally cylindrical shaped support having permanent magnets secured to its inner surface, an output shaft coaxially mounted to the rotor therein and a coupling assembly that biases the cooling assembly onto the stator and operatively mounts together the stator and cooling assembly to the output shaft. Mounting the shaft to the rotor and to the liquid cooling system yields a compact assembly where no housing is required for the alignment of the stator and rotor.

### FIELD

The present disclosure generally relates to electric machines. More specifically, the present disclosure is concerned with a liquid cooled external rotor electric machine that may be used without a housing.

### BACKGROUND

External rotor electric machines conventionally include a housing to which both rotor and stator are mounted; the stator being fixedly mounted thereto while the rotor is rotatably mounted to the housing via bearings provided therebetween. A drawback of such conventional assembly is that all the parts must be manufactured with high tolerances so that the air gap between the rotor and stator is sufficiently small.

### SUMMARY

The difficulty of aligning the rotor and stator in a liquid cooled external rotor electric machine is hereby solved by providing an internal shaft to the external rotor, by rotatably mounting the shaft to the cooling system and by mounting the cooling system in the stator.

In accordance with an illustrative embodiment, there is provided a liquid cooled external rotor electric machine comprising:

a stator having an internal surface;

a liquid cooling assembly having internal and external surfaces;

an external rotor including a generally cylindrically shaped receptacle having an internal surface; and

an output shaft coaxially mounted to the cylindrical shaped receptacle of the rotor;

wherein the liquid cooling assembly is so mounted to the stator that the external surface of the liquid cooling assembly contacts the internal surface of the stator; and wherein the output shaft is rotatably mounted to the internal surface of the liquid cooling assembly, coaxially therewith.

Other objects, advantages and features will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a perspective view of a liquid cooled external rotor electric machine according to an illustrative embodiment;

FIG. 2 is a front elevation view of the electric machine from FIG. 1;

FIG. 3 is a side elevation view of the electric machine from FIG. 1;

FIG. 4 is cross-sectional view of the electric machine from FIG. 1;

FIG. 5 is a first exploded view of the electric machine from FIG. 1;

FIG. 6 is a second exploded view of the electric machine from FIG. 1, showing the assembly thereof;

FIG. 7 is a perspective view similar to FIG. 1, showing the electric machine with an interface end cap; and

FIG. 8 is a cross-sectional view similar to FIG. 4, illustrating an alternate embodiment of the liquid cooled external rotor electric machine.

### DETAILED DESCRIPTION

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The expression “electric machine” should be construed herein and in the appended claims broadly so as to include electric motors, electric generators and the like.

The expression “connected” should be construed herein and in the appended claims broadly so as to include any cooperative or passive association between mechanical parts or components. For example, such parts may be connected together by direct coupling, or indirectly connected using further parts therebetween.

The expression “piping” should be construed broadly in the description and in the claims as including any fluid conduit, that is closed, opened, or partially opened, of any shape, size or material, and that is used to receive fluid thereon or therein, and includes, without limitations, hoses, pipes and other types of tubing.

Generally stated, described herein is a liquid cooled external rotor electric machine that is housing-less and where the stator and the rotor are already assembled together.

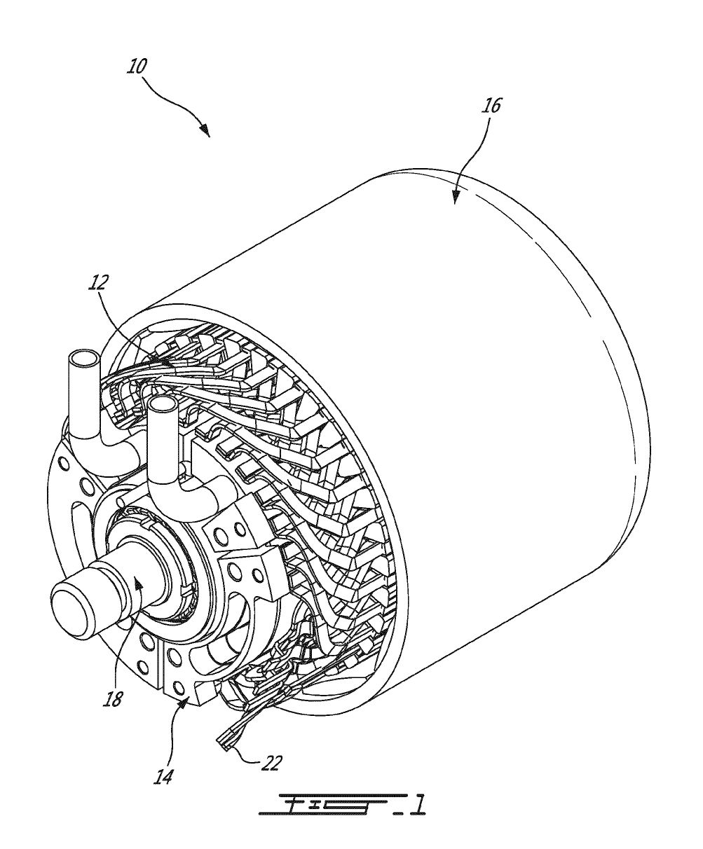

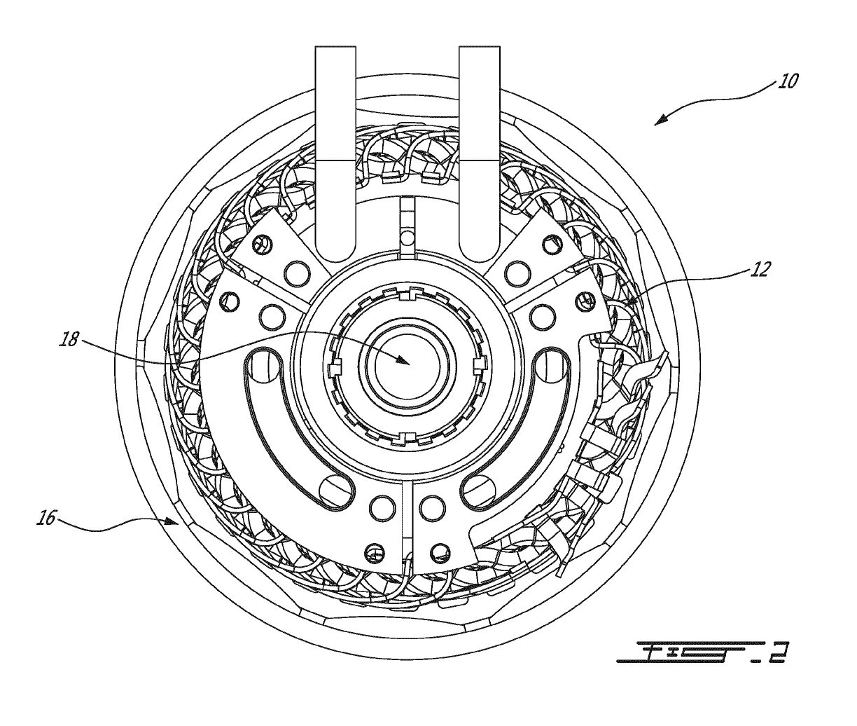

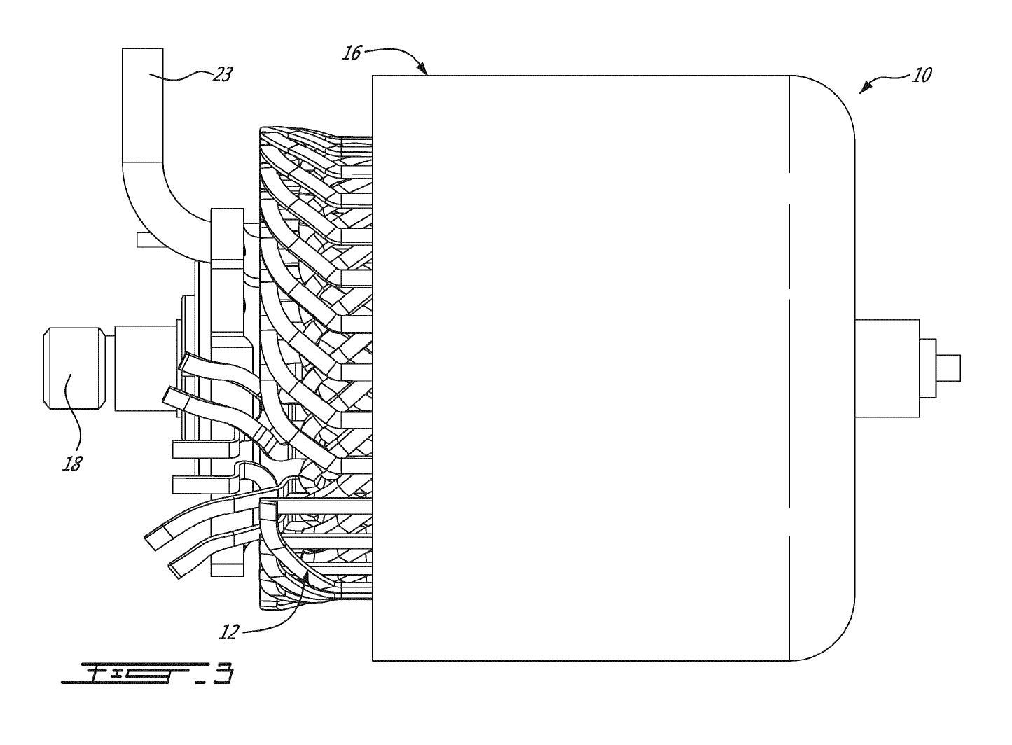

With reference first to FIGS. 1 to 6 of the appended drawings, a liquid cooled external rotor electric machine 10 according to an illustrated embodiment will now be described.

The liquid cooled external rotor electric machine 10 includes an internal stator 12 having an internal surface, a generally cylindrical cooling assembly 14 secured to the stator 12 therein so that an external surface of the cooling assembly 14 contacts the internal surface of the stator 12, an external rotor 16, an output shaft 18 coaxially mounted to the rotor 16, and a coupling assembly 20 that biases the cooling assembly 14 onto the stator 12 and that operatively mounts together the stator 12 and cooling assembly 14 to the output shaft 18 for rotation of the output shaft 18 therein. In other words, the output shaft 18 is coaxially and rotatably mounted to the internal surface of the liquid cooling assembly 14.

The stator 12 includes a cylindrical copper field coil assembly having input terminals 22 and mounted to a stack of laminations 13. It is to be noted that the stator 12 is not limited to the illustrated embodiment, including its geometry and material that may differ to those illustrated and described.

Since stators of electric machines are believed to be well known to those skilled in the art, the stator 12 will not be further described herein for concision purposes.

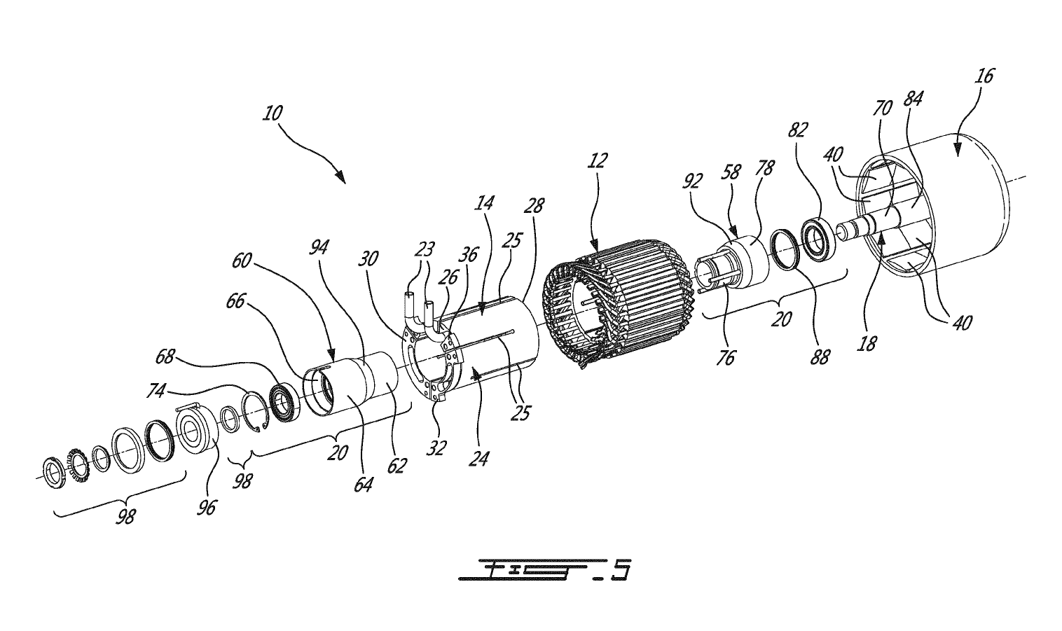

As can be better seen from FIG. 5, which illustrates an exploded view of the electric machine 10, the liquid cooling assembly 14 includes a generally tubular body 24 extending between proximate and distal longitudinal ends 26 and 28. The tubular body 24 being provided with internal and external surfaces.

The body 24 includes a serpentine-shaped conduit (not shown) that extends generally throughout its volume between infeed and outlet openings (not shown) and that define a passage for a cooling fluid therein. The liquid cooling assembly 14 includes two piping sections 23 that are connected to the body's aperture via the infeed and outlet openings.

The body 24 is provided with a series of elongated slots 25, each extending longitudinally along a portion of its length alternatively from the proximate and distal ends 26 and 28 and throughout its thickness. As will be described hereinbelow in more details, the slots 25 allow small radial deformations of the body 24.

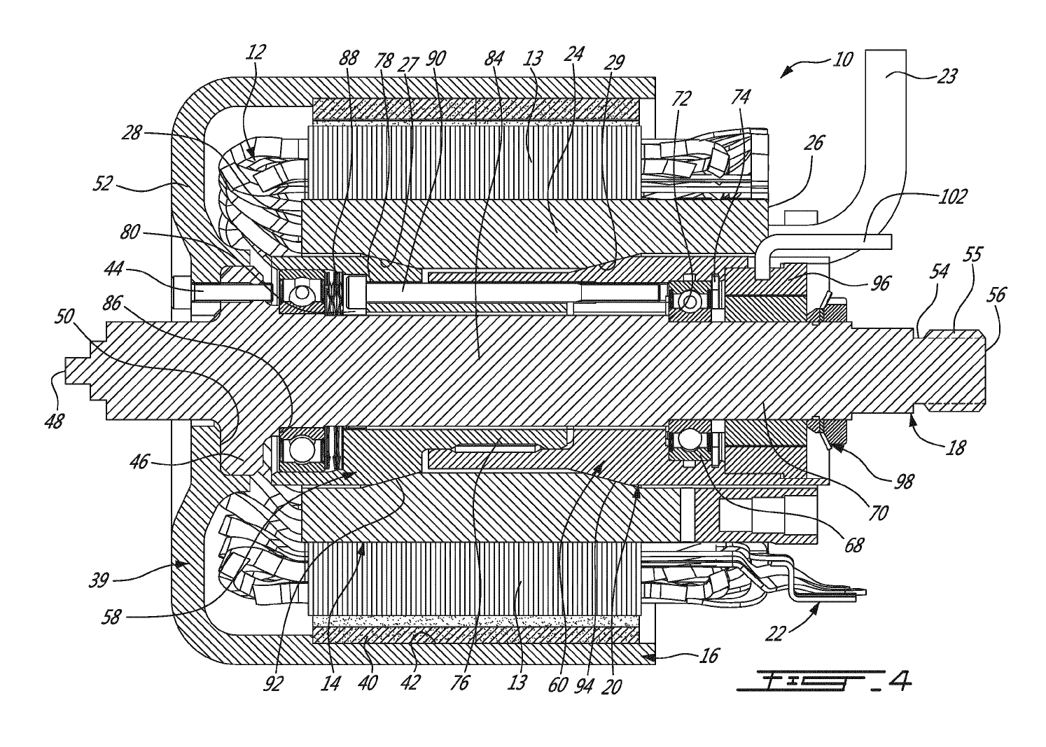

As can be better seen from FIG. 4, the internal surface of the tubular body 24 includes a constriction defined by first and second angled wall portions 27 and 29.

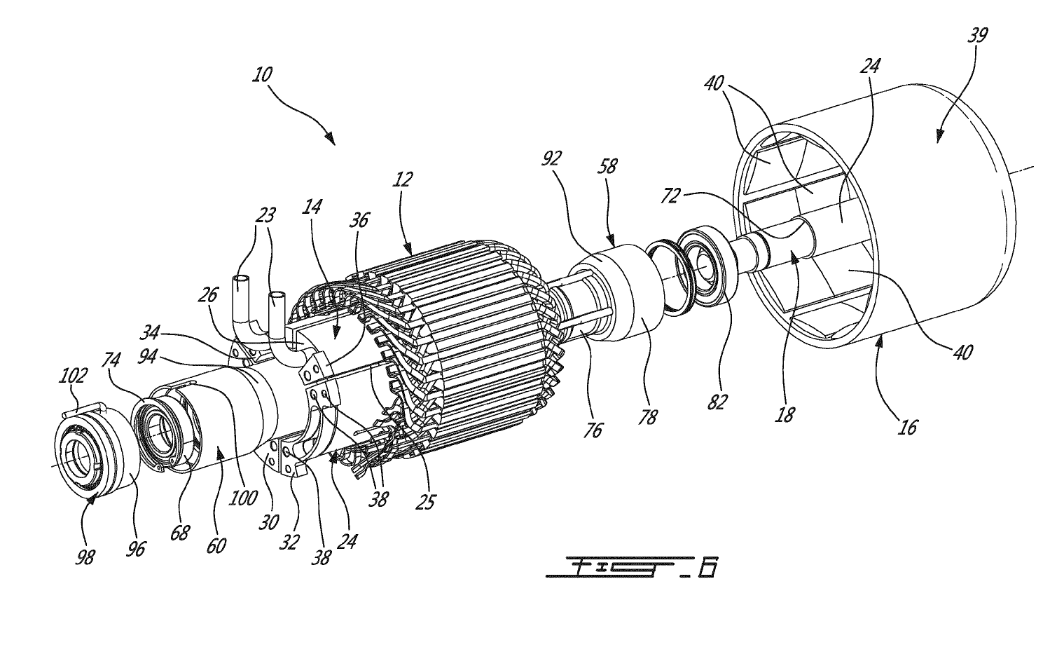

The assembly 14 also includes flange sections 30-36 secured to the body 24 at the proximate end 26 thereof, each section 30-36 including one or more pairs of fastener-receiving holes 38 (see FIG. 6).

The liquid cooling assembly 14 is further described in U.S. Pat. No. 8,378,534 issued on Feb. 19, 2013 and entitled: “Liquid cooling arrangement for electric machines”, which is incorporated herein by reference.

According to another embodiment (not shown), the serpentine-shaped conduit in the body 24 is replaced by tubing therein.

The rotor 16 includes a cylindrical-shaped receptacle 39 having permanent magnets 40 secured to its inner surface 42. The permanent magnets 40 are secured in the rotor 16 using glue or other types of mechanical or chemical fastening.

As can be better seen in FIG. 4, the output shaft 18 is coaxially mounted to the rotor 16 using fasteners 44 (only one shown). According to another embodiment (not shown), the output shaft 18 is integral with the rotor 16.

The shaft 18 is further provided with an integral flange 46 near its distal end 48 that is received in a rounded cavity 50 formed into the bottom 52 of the receptacle 39. The shaft 18 further includes a conventional annular groove 54 near its proximate end 56, defining a splined connecting portion 55 thereof. It is well known in the art to use a splined connecting portion of the shaft 18 to operatively couple a machine or tool to the electric machine 10, and therefore such coupling will not be described herein in more detail. Furthermore, the splined portion 55 could be replaced by a key and keyway arrangement (not shown) or by any other suitable connection element.

As mentioned hereinabove, the coupling assembly 20 allows i) biasing the cooling assembly 14 onto the stator 12 and ii) operatively mounting together the stator 12 and cooling assembly 14 to the output shaft 18.

The coupling assembly 20 includes complementary male and female connecting parts 58 and 60. The female part 60 includes a narrow cylindrical portion 62 that is shaped to receive the male part 58 in a complementary manner and an integral enlarged portion 64 including a cavity 66 that receives a first bearing 68 in a snugly fit manner. The inner diameter of the bearing 68 is dimensioned to receive a complementary section 70 of the shaft 18. The bearing 68 abuts a shoulder 72 at the distal end of the section 70. A retaining ring 74 is positioned onto the bearing 68 within the cavity 66.

The male part 58 of the coupling assembly 20 includes a narrow cylindrical portion 76 is shaped and sized for insertion into the narrow portion 62 of the female part 60. The inner diameter of the narrow portion 76 is sufficiently large to allow passage to the shaft 18 therethrough.

Similarly to the female part 60, the male part 58 includes and an enlarged portion 78 that includes a cavity 80 that receives a second bearing 82 in a snugly fit manner. The inner diameter of the bearing 82 is dimension to receive a complementary section 84 of the shaft 18. The bearing 82 abuts a shoulder 86 at the distal end of the section 84. A biasing element, in the form of a wave spring 88 is positioned onto the bearing 82 within the cavity 80. The bottom of the cavity 80 includes holes (not shown) to receive fasteners 90 (only one shown). The narrow portion 62 of the female part 60 includes threaded holes (not shown) for receiving the fasteners 90.

Both male and female parts 58 and 60 include tapered portions 92 and 94 between their respective narrow and enlarged portions. The parts 58 and 60 are received in respective complementary longitudinal end portions of the body 24. Fasteners 90 are used to assemble and move towards each other the male and female portions 63 and 78, causing the tapered portions 92 and 94 of the coupling assembly to respectively contact the complementary angled wall portions 27 and 29 of the internal surface of the body 24 and force them outwardly. Accordingly, the diameter of the cylindrical body 24 slightly increases, as allowed by the slots 25. This causes the body 24 to firmly contact the stator 12, thereby causing their attachment. Of course, the body 24 is inserted into the stator 12, previously to the assembly of the male and female parts 58 and 60.

Accordingly, the male and female parts can be viewed as biasing elements of an internal biasing assembly including the fasteners 90.

The cavity 66 further receives a resolver 96 which is positioned and maintained in place by an ensemble 98 of spacers and biasing members that also maintains the bearing inner race. For that purpose, the wall of the cavity 66 includes a groove 100 to accommodate a connector 102 of the resolver 96.

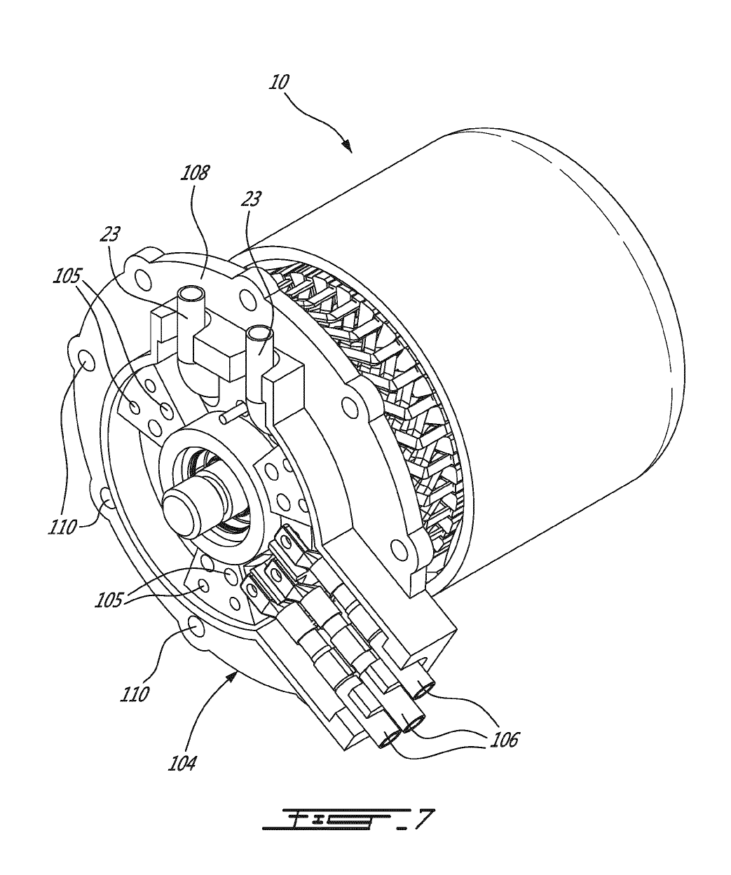

As can be seen in FIG. 7, an interface end cap 104 is inserted over the shaft 18 through the distal end 56 thereof and secured to the flange sections 30-36 (see FIG. 6) using for example fasteners (not shown) inserted through apertures 105. The interface end cap 104 is shaped to receive and position the piping 23 and connectors 106 respectively provided cooling fluid and electrical connection to the electric machine 10. The interface end cap 104 is provided with a flange 108 that includes apertures 110 for receiving fasteners for securing the electric machine 10 to a structure (not shown).

One skilled in the art will understand that by using an interface end cap such as 104 to mount the electric machine 10 to a structure, it is possible to design a single electric machine that can be used with different structures by providing appropriate interface end caps.

According to another embodiment (not shown), the resolver 96 is omitted and a Hall effect system is used to provide the angular position of the rotor 16 relative to the stator 12.

According to still another embodiment (not shown), another coupling assembly than the one illustrated is used to bias the cooling assembly 14 onto the stator 12 and operatively mounting together the stator 12 and cooling assembly 14 to the output shaft 18.

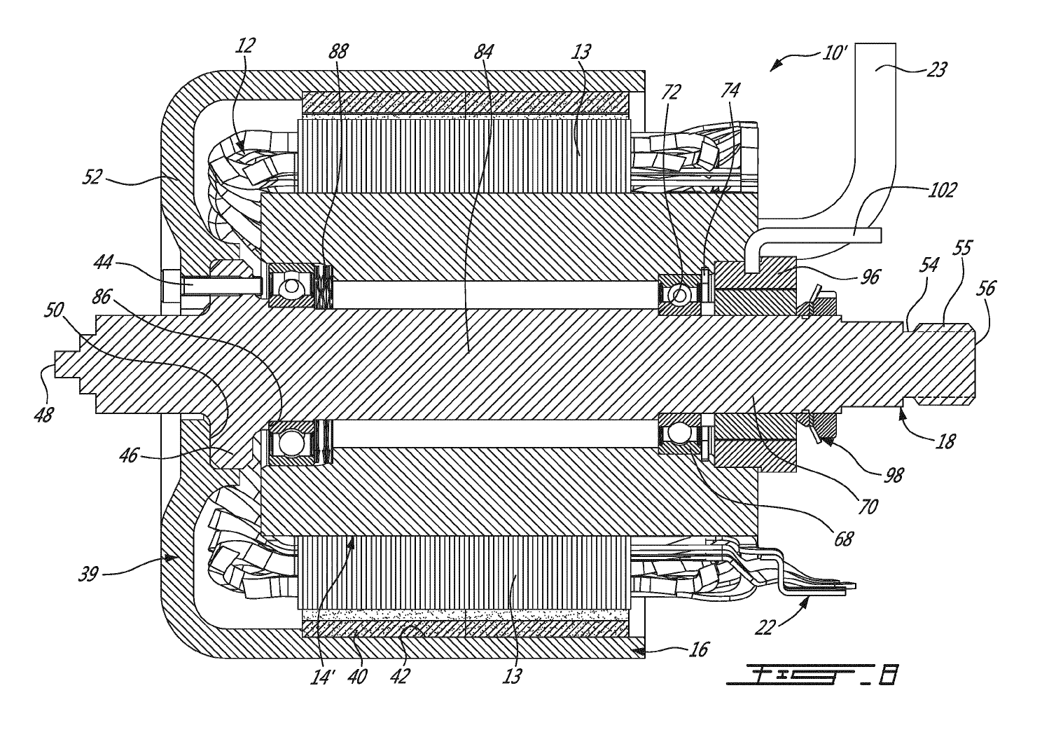

FIG. 8 illustrates a liquid cooled external rotor electric machine 10′ where the bearings are mounted directly to the cooling assembly 14′. When such an assembly is used, the interconnection of the cooling assembly 14′ and the laminations 13 of the stator is done according to a press-fit method and can use thermally conducting adhesive.

One skilled in the art will easily understand that the above-described arrangements provide cooling for both the stator and the bearings.

Furthermore, since the external rotor, provided with the shaft 18 is internally and coaxially mounted to the stator via bearings, alignment between the rotor and the stator is simplified, allowing the air gap therebetween to be optimized.

It is to be noted that while a permanent magnet electric machine was described herein, other types of electric machines could benefit from the present teachings.

It is to be understood that the liquid cooled external rotor electric machine is not limited in its applications to the details of construction and parts illustrated in the accompanying drawings and described hereinabove. The electric machine is capable of other embodiments and of being practiced in various ways. It is also to be understood that the phraseology or terminology used herein is for the purpose of description and not limitation. Hence, although the electric machine has been described hereinabove by way of illustrative embodiments thereof, it can be modified, without departing from the spirit, scope and nature of the subject invention.

1. A liquid cooled external rotor electric machine comprising:
a stator having an internal surface;
a liquid cooling assembly having internal and external surfaces;
an external rotor including a generally cylindrically shaped receptacle having an internal surface; and
an output shaft coaxially mounted to the cylindrical shaped receptacle of the rotor;
wherein the liquid cooling assembly is so mounted to the stator that the external surface of the liquid cooling assembly contacts the internal surface of the stator; and wherein the output shaft is rotatably mounted to the internal surface of the liquid cooling assembly, coaxially therewith.

2. The electric machine of claim 1, further comprising a biasing assembly biasing the external surface of the cooling assembly against the internal surface of the stator.

3. The electric machine of claim 2, wherein the biasing assembly is an internal biasing assembly mounted to the internal surface of the liquid cooling assembly and configured and sized to provide an outwardly directed biasing force to apply the external surface of the cooling assembly against the internal surface of the stator.

4. The electric machine of claim 3, wherein the internal surface of the cooling assembly is provided with a constriction defined by first and second angled wall portions; the internal biasing assembly includes first and second biasing elements each provided with a tapered portion configured and sized to contact a respective angled wall portion of the tubular body, and with at least one fastener interconnecting the first and second biasing elements; wherein the at least one fastener is so mounted to the first and second biasing elements that rotation of the fastener forces the second biasing element towards the first biasing element thereby applying an outwardly directed biasing force to apply the external surface of the cooling assembly against the internal surface of the stator.

5. The electric machine of claim 4, wherein the cooling assembly includes longitudinal slots allowing slight deformation of the cooling assembly.

6. The electric machine of claim 1, wherein the output shaft is rotatably mounted to the internal surface of the liquid cooling assembly via a pair of bearings interposed between the output shaft and the internal surface of the cooling assembly.

7. The electric machine of claim 6, wherein the bearings are mounted to an internal biasing assembly mounted to the internal surface of the cooling assembly.

8. The electric machine of claim 1, wherein the rotor includes permanent magnets secured to the internal surface of the cylindrically shaped receptacle.

9. The electric machine of claim 1, wherein the corresponding internal surface of the stator and the external surface of the cooling assembly are cylindrical.

10. The electric machine of claim 1, wherein the liquid cooling assembly includes a cooling tube embedded therein, the cooling tube including an inlet and an outlet.
